(19) United States
(12) Patent Application Publication
(10) Pub. No.: US 2023/0395824 A1
(43) Pub. Date: Dec. 7, 2023

(54) FUEL CELL POLAR PLATE STRUCTURE AND FUEL CELL STACK

(71) Applicant: Cemt Co., Ltd., Zhejiang (CN)

(72) Inventors: Liming XU, Jiaxing City (CN); Guanghui SONG, Jiaxing City (CN); Shuaiying MA, Jiaxing City (CN)

(21) Appl. No.: 18/272,463

(22) PCT Filed: Dec. 13, 2021
(86) PCT No.: PCT/CN2021/137477

§ 371 Date: Jul. 14, 2023

(30) Foreign Application Priority Data
Sep. 7, 2021 (CN) 202111042687.1

(51) Int. Cl. H01M 8/026; H01M 8/1004; H01M 8/248

(52) U.S. Cl. CPC H01M 8/026; H01M 8/1004; H01M 8/248

(57) ABSTRACT

Disclosed are a fuel cell polar plate structure and a fuel cell stack, including a battery block comprising a bipolar plate, carbon papers, water-holding sheets and a proton exchange membrane; said bipolar plate has a reaction bath opened on the outer surface of each polar plate body; the front and rear sides of the reaction bath are provided with water crossing ports formed with grooves extending into the reaction bath; the fuel cell stack comprising a plurality of battery blocks, current collectors, insulating plates and end plates, wherein said battery blocks being stacked end to end to form a battery pack, and pressure-adjustable fixing mechanisms are fixed to the outer surfaces of the end plates. The independent anti-dry design improves the power generation effect and the fixing pressure regulating structure facilities controlling of the pressure between the polar plates and slows down the aging of the sealing ring.

### TECHNICAL FIELD

The present invention relates to the technical field of electrochemistry, specifically, to a fuel cell polar plate structure and a fuel cell stack.

### BACKGROUND

Fuel cell stack is mainly composed of polar plates (bipolar plates), proton exchange membranes, current collector plates and insulating plates. The proton exchange membranes and polar plates constitute a single cell, and multiple single cells are stacked together to form a battery pack. There are many ways to fix the battery pack, the most common one is fixed by end plates and bolts, and the end plates are fixed at both ends of the battery pack, and the two end plates are fixed by bolts. A fixing pressure control will affect the resistance between the polar plates and gas flow, thus affecting the power generation performance.

Polar plate is the key component in the fuel cell stack, and the flow field design of the polar plate needs to consider factors such as medium uniformity, hydrothermal management, contact resistance and support strength, etc. Good or bad flow field design greatly affects the power generation performance of the point stack.

Chinese invention patent publication No. CN109830705A discloses a fuel cell polar plate structure and a stack, the polar plate structure includes a polar plate, said polar plate is provided with a fuel inlet, an air inlet and a coolant inlet, and a fuel outlet, an air outlet and a coolant outlet, said air inlet and air outlet are provided with a flow channel to form a flow field, said flow channel includes a number of flow limiting channels said flow limiting channels are provided at the inlet and outlet to limit the inlet and outlet flow rates or/and flow rates, and a plurality of branch channels are provided between the inlet and outlet side flow limiting channels, the bottom surface of said branch channels forming a certain inclination angle with the plane where the polar plates are located.

However, there are some problems with this flow channel design and the fixation of the stack. Firstly, there is no independent anti-dry design in the polar plate, and the wetting of the proton exchange membrane can only be done by the water generated by its own reaction or by the injection of water through the coolant inlet, and such wetting method is ineffective, as the water cannot directly contact the proton exchange membrane and needs to pass through the carbon paper before it can contact the proton exchange membrane for wetting.

Secondly, the fixing of the reactor is not done for the treatment. The traditional fixing method has no pressure regulating structure, and the long-term high pressure fixing can ensure the tightness between the plates, which reduces the resistance between the plates and ensures the sealing, but the long-term high pressure fixing accelerates the aging of the sealing ring and affects the service life of the fuel cell stack.

Therefore, there is an urgent need to design a fuel cell polar plate structure and fuel cell stack to solve the above problems.

### SUMMARY

The purpose of the present invention is to provide a fuel cell polar plate structure and electric stack to solve the problems of no independent anti-water dry design and no pressure regulating structure, which accelerate the aging of the sealing ring and affect the service life of the electric stack, as proposed in the above background technology.

In order to achieve the above purpose, the present invention provides the following technical solutions:
a fuel cell polar plate structure, including a battery block, said battery block consists of a bipolar plate, carbon papers and a proton exchange membrane, wherein said battery block further comprises water-holding sheets; said bipolar plate includes two plate bodies; each said plate body has a reaction bath opened on the outer surface; the left and right sides of said reaction bath are provided with inlet outlet holes and the front and rear sides of the reaction bath are provided with water crossing ports; said water crossing ports penetrate through the outer surface of the plate body, and grooves are formed in the surfaces of the water crossing ports and extend into the reaction bath, and there are guide slots evenly distributed on the inner wall of the grooves; the number of said carbon paper and water-holding sheet are both two, and said two carbon papers are respectively stacked with a water-holding sheet between the carbon paper and the proton exchange membrane, and are respectively distributed on both sides of the proton exchange membrane.

Preferably, the carbon paper and the water-holding sheet are embedded in the reaction bath, and the guide slots are distributed between the carbon paper and the water-holding sheet, and both sides of the water-holding sheet are integrally connected with a water-permeable block which is embedded in the water crossing port.

Preferably, the water-holding sheet is honeycomb-shaped, and is made of a mixture of activated carbon and perfluorosulfonic acid resin.

A fuel cell stack comprising a plurality of battery blocks, current collectors, insulating plates and end plates, said battery blocks being stacked end to end to form a battery pack, and said current collectors being distributed on both sides of the battery pack; the insulating plates are attached to the side surfaces of the current collectors, the end plates are attached to the side surfaces of the insulating plates, and pressure-adjustable fixing mechanisms are fixed to the outer surfaces of the end plates; said pressure-adjustable fixing mechanism comprising a housing, inside the housing is provided with a servo motor which is fixed to the end plate, and an active bevel gear is fixed at the output end of said servo motor, and both sides of said active bevel gear are engaged with a driven bevel gear, and an inside of each said driven bevel gear is telescopically connected with a push rod, and the end of the push rod back from the driven bevel gear penetrates the housing and abuts two curved pieces, and an end of the curved piece back from the push rod holds on to a tie rod.

Preferably, a bearing sleeve is attached to an outer surface of said driven bevel gear by means of a bearing which is fixed to the end plate; one end of said push rod is tapered, and an outer surface of the other end of said push rod is formed with an external thread; an inner wall of said driven bevel gear is provided with an internal thread, and the push rods are in threaded connection with the driven bevel gears.

Preferably, both ends of said curved piece are curved and said curved piece is against the outer surface of the end plate; both ends of said tie rod are provided with U-shaped notches, a shaft pin is fixed in the U-shaped notch, and said curved piece is inserted in the U-shaped notch and against the shaft pin; an end of said curved piece against the push rod is thickening outwardly, the number of said tie rod is four, both ends of each said tie rod cooperate with two curved pieces.

Preferably, said curved piece is provided with a pressure seat at one end near the tie rod, said pressure seat consists of a pressure rod and connection blocks, the pressure rod presses against the lowest point of an arc-shaped surface of the curved piece, both ends of the pressure rod are each fixed to a connection block, and the connection blocks are fixed to the end plate.

Preferably, the outer surface of said push rod is fitted with a linear bearing, and said linear bearing is fixed to an inner wall of the housing.

Compared with the prior art, the beneficial effect of the present invention is that the fuel cell polar plate structure and the fuel cell stack have an independent anti-dry design and a fixing pressure regulating structure, which facilitates the adjustment of the fixing pressure, thus controlling the pressure between the polar plates and solving the problem of the seal ring being in a high pressure state for a long time.

(1) By opening water crossing ports on the plate bodies, grooves extending to the reaction bath inside the water crossing port, and guide slots evenly opened inside the grooves, and by providing a water-holding sheet set between the carbon paper and the proton exchange membrane, water can be fed independently through water crossing ports, and water flows to the water-holding sheets through the guide slots, thus wetting the proton exchange membrane, ensuring that the proton exchange membrane is always wet, improving the proton conduction effect, and improving the power generation effect.

(2) Both lateral sides of the two end plates are provided with tie rods which can be pulled through the curved pieces; the servo motor drive the driven bevel gears rotates through the active bevel gear, which can drive the push rods expand and retract, so as to push one end of the curved piece and so that the other end of the curved piece pries the corresponding tie rod, so as to push the two end plates to adjust the pressure of clamping the battery pack; when the battery pack is not working, the fixing pressure of the battery pack can be reduced through the pressure-adjustable fixing mechanism to reduce the pressure on the sealing rings; and then adjust the pressure back when working to meet the working demand of the battery pack; and the elastic adjustment slows down the aging of the sealing ring to enhance the service life of the fuel cell stack.

### BRIEF DESCRIPTION OF THE DRAWINGS

FIG. 1 is a schematic diagram of the structure of the present invention as a whole;

FIG. 2 is a side view sectional schematic diagram of the structure of the adjustable pressure fixing mechanism in FIG. 1 of the present invention; and

FIG. 3 is a schematic diagram of the structure of the arch piece in FIG. 1 of the present invention as a whole

FIG. 4 is an exploded schematic diagram of the structure of the battery block in FIG. 1 of the present invention; and

FIG. 5 is an enlarged schematic diagram of the structure at A in FIG. 4 of the present invention.

In the figure: 1, battery block; 11, bipolar plate; 111, plate body; 112, inlet outlet hole; 113, reaction bath; 114, water crossing port; 12, carbon paper; 13, water-holding sheet; 14, proton exchange membrane; 2, current collector; 3, insulating plate; 4, end plate; 5, pressure-adjustable fixing mechanism; 51, housing; 52, servo motor; 53, active bevel gear; 54, driven bevel gear; 55, bearing sleeve; 56, linear bearing; 57, push rod; 58, curved piece; 59, tie rod; 510, pressure seat.

### DETAILED DESCRIPTION OF THE EMBODIMENTS

The specific embodiments provided by the present invention are described in detail below in conjunction with the accompanying drawings.

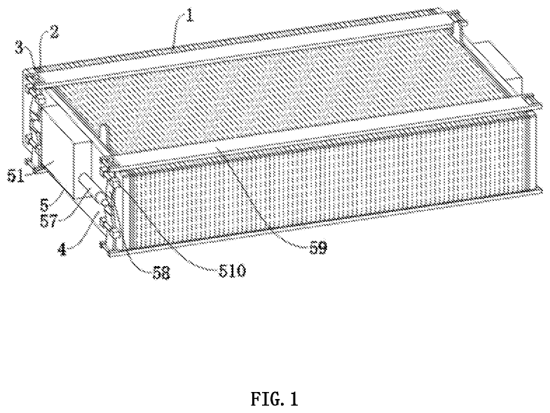

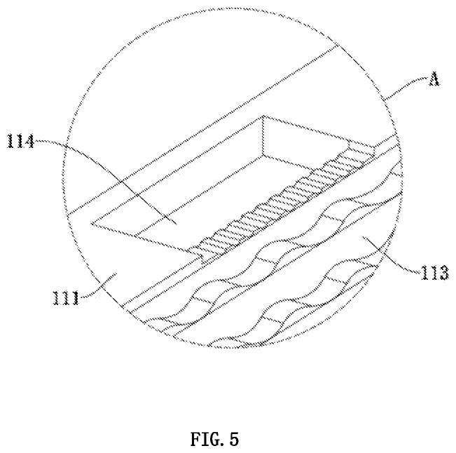

The present invention will be described in detail in the following in connection with the accompanying FIGS. 1 to 6 to provide a clear and complete description of the technical solutions in the embodiments of the present invention. Obviously, the described embodiments are only a part of the embodiments of the present invention, and not all of them. Based on the embodiments in the present invention, all other embodiments obtained by a person of ordinary skill in the art without making creative labor fall within the scope of protection of the present invention.

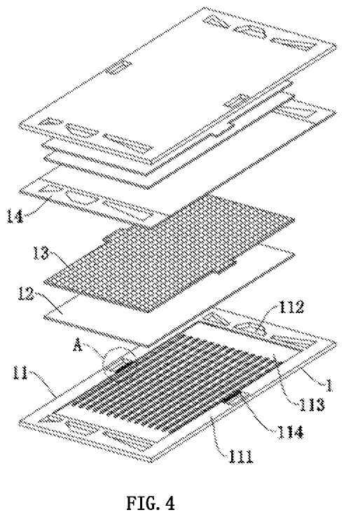

As shown in FIGS. 1,5, the present invention proposes an embodiment of a fuel cell polar plate structure, including a battery block 1, said battery block 1 consists of a bipolar plate 11, carbon papers 12, water-holding sheets 13 and a proton exchange membrane 14, said bipolar plate includes two plate bodies 111, each said plate body 111 has a reaction bath 113 opened on the outer surface, said reaction bath has inlet outlet holes 112 on both the left and right sides, said reaction bath has water crossing ports 114 on both the front and rear sides, said water crossing port 114 penetrates the outer surface of the plate body, a groove is opened on the surface of said water crossing port, the groove extends into the reaction bath 113, and there are guide slots evenly distributed on the inner wall of the groove, the number of said carbon papers and water-holding sheets are both two, and each said carbon paper and water-holding sheet are stacked and distributed on each side of the proton exchange membrane. As shown in FIG. 4, the number of inlet outlet holes is six, and both sides of the plate body 111 are opened with three inlet outlet holes, with one end used for inlet and one end used for outlet; hydrogen and air are introduced into reaction bath 113 through inlet outlet holes 112, and then react on proton exchange membrane 14 after catalyzed by carbon paper 12 to separate electrons, which is the prior art and will not be elaborated here. By opening the water crossing port 114 on the plate body 111, opening a groove inside the water crossing port 114 extending to the reaction bath 113, and evenly opening guide slots inside the groove, and setting a water sheet 13 between the carbon paper 12 and the proton exchange membrane 14, the water can be fed independently through the water crossing port 114, and the water flows to the water-holding sheet 13 through the guide slots, thus wetting the proton exchange membrane 14, ensuring that the proton exchange membrane 14 is always wet and improving the proton conduction effect.

Further, As shown in FIG. 4, the carbon paper 12 and the water-holding sheet 13 are embedded in the reaction bath, and the guide slots are distributed between the carbon paper 12 and the water-holding sheet 13, and both sides of the water-holding sheet 13 are integrally connected with a water-permeable block, and the water-permeable block is embedded in the water crossing port 114. The water-permeable block plays a role in transitioning the water flowing out of the water crossing port 114 to the water-holding sheet 13, and the material of the water-permeable block is the same as the water-holding sheet 13.

Further, As shown in FIG. 4, the water-holding sheet is honeycomb-shaped, which is conducive to the uniform distribution of water to the water-holding sheet 13, and gathered on the surface of the water-holding sheet 13; and the water-holding sheet 13 is made of activated carbon and perfluorosulfonic acid resin mixture; activated carbon has good conductive effect, enhancing the conductivity between the carbon paper 12 and the proton exchange membrane 14; perfluorosulfonic acid resin, with good catalytic performance, can enhance the catalytic effect when cooperates with activated carbon.

A fuel cell stack comprising a plurality of battery blocks 1, current collectors 2, insulating plates 3 and end plates 4, said battery blocks 1 being stacked end to end to form a battery pack, and said current collectors 2 being distributed on both sides of the battery pack; the current collectors 2 are used to collect current, centralize drainage exhaust and conduct electricity. The insulating plates 3 are attached to the side surfaces of the current collectors 2, the end plates 4 are attached to the side surfaces of the insulating plates 3. Insulating plate 3 plays the role of insulation, end plate 4 has an air inlet pipe and water inlet pipe (not shown) installed on the surface, and the air inlet pipe and water inlet pipe extend to the current collector 2 and connect with the inlet outlet hole 112.

Each said end plate 4 having an pressure-adjustable fixing mechanism fixed 5 on its outer surface, said pressure-adjustable fixing mechanism 5 comprises a housing 51, inside the housing 51 is fixed with a servo motor 52, an active bevel gear 53 is fixed at the output end of said servo motor 52, and both sides of said active bevel gear 53 are engaged with a driven bevel gear 54, a push rod 57 is telescopically connected to the inside of each said driven bevel gear 54, the end of the push rod 57 back from the driven bevel gear 54 penetrates the housing 51 and is in abutting connection with an curved piece 58, the end of the curved piece 58 back from the push rod 57 is connected to a tie rod 59. By the servo motor 52 driving the active bevel gear 53, the driven bevel gears 54 can be driven to rotate, so that the push rods 57 extend and retract in the housing 51 and penetrate through the housing 51 to push one end of the curved piece 58, so that the other end of the curved piece 58 pries the tie rod 59, adjusting the spacing between the two end plates 4, controlling the fixing pressure between the battery pack; this fixed structure also has the effect of convenient disassembly, when the two push rods 57 completely retracted, the push rod 57 is completely free from the curved piece 58, lifting the restriction on the curved piece 58, and then wrench the curved piece 58 to the side away from the end plate 4, so that the curved piece 58 can be detached from the tie rod 59, thus disassembling the battery pack.

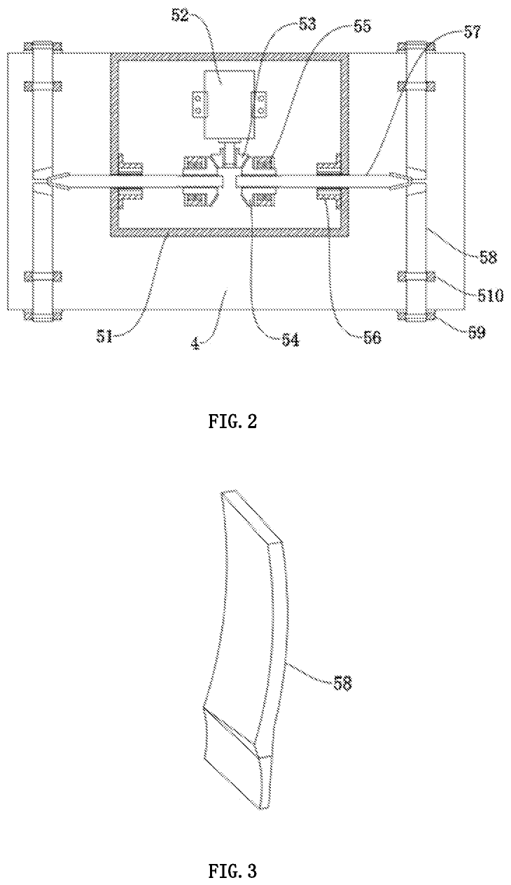

Further, as shown in FIGS. 1-2, a bearing sleeve 55 is attached to the outer surface of said driven bevel gear 54 by means of a bearing, said bearing sleeve 55 is fixed to the end plate 4 so that the driven bevel gear 54 can rotate stably in the housing 51; one end of said push rod 57 is tapered, and the other end of said push rod 57 is provided with an external thread on the outer surface, and the inner wall of said bevel gear is provided with an internal thread, and said push rod 57 is connected to the driven bevel gear 54 through a threaded connection. By rotating the driven bevel gear 54, the internal threads can push the external threads so that the push rod 57 pushes the curved piece 58, and since the end of the push rod 57 against the curved piece 58 is tapered, when the push rod 57 moves toward the curved piece 58, it will push the curved piece 58 closer to the end plate 4, so that the other end of the curved piece 58 pries the tie rod 59.

Further, as shown in FIGS. 1-3, both ends of said curved piece 58 are curved and said curved piece 58 is against the outer surface of the end plate 4, both ends of said tie rod 59 are provided with a U-shaped slot, a shaft pin is fixed in the U-shaped slot, said curved piece 58 is inserted in the U-shaped slot and against the shaft pin. The curved piece 58 projects out of the U-shaped slot, the other end of the curved piece 58 abuts against the other curved piece 58, the sides of the curved piece 58 abut against the inner wall of the U-shaped slot, and the portion of the curved piece 58 that projects out of the arc-shaped slot is wider so as to avoid the curved piece 58 from falling out of the inner U-shaped slot;

The end of said curved piece 58 against the push rod 57 is gradually thickening outwardly, so that the end of curved piece 58 connecting with the tapered end of push rod 57 is wedge-shaped, just cooperating with the tapered end of push rod 57, reducing the resistance of the push rod 57 pushing the curved piece 58; the number of said tie rod 59 is four, both ends of each said tie rod 59 cooperate with two curved pieces 58. The curved piece 58 is designed in an arc shape, and the lowest point of the curved piece 58 abuts against the end plate 4 to form a pivot point, forming a lever structure.

Further, as shown in FIGS. 1-2, said curved piece 58 is provided with a pressure seat 510 at one end near the tie rod 59, said pressure seat 510 consists of a pressure rod and connection blocks, the pressure rod abuts the lowest point of the arc-shaped surface of the curved piece, both ends of the pressure rod are each fixed to a said connection block, and the connection blocks are fixed to the end plate, which improves the connection stability between curved piece 58 and end plate 4.

Further, as shown in FIGS. 1-2, the outer surface of said push rod is provided with a linear bearing 56, and said linear bearing 56 is fixed to the inner wall of the housing, which improves the extend-retract friction of pushing rod 57 and reduces the pushing force needed in the movement of pushing rod 57.

Working principle: When using, by connecting the air inlet pipe and water inlet pipe on the end plate 4 with the external hydrogen, air and coolant conduit correspondingly, the hydrogen, air and coolant are introduced into the water-holding sheet 13 through the inlet outlet holes 112, and then react on the proton exchange membrane 14 through the carbon papers 12 to separate the electrons, which is the existing technology and will not be elaborated too much here.

By opening water crossing ports 114 on the plate bodies 111, a groove extending to the reaction bath inside the water crossing port 114, and guide slots evenly opened inside the groove, and by providing a water-holding sheet 13 set between the carbon paper 12 and the proton exchange membrane 14, water can be fed independently through water crossing port 114, and water flows to the water-holding sheet 13 through the guide slots, thus wetting the proton exchange membrane 14, ensuring that the proton exchange membrane 14 is always wet, improving the proton conduction effect, and improving the power generation effect.

By the servo motor 52 driving the active bevel gear 53 to rotate, the active bevel gear drives the driven bevel gear to rotate, and by the rotation of driven gear 54, the internal thread can push the external thread, so that the push rod 57 pushes the curved piece 58, and because the end of the curved piece abutting against the pushing rod is tapered, when the push rod 57 is moving towards the curved piece 58, the curved piece 58 will be pushed to move close to the end plate 4, so that the other end of the curved piece 58 pries the tie rods and then push two end plates 4 to adjust the pressure of clamping the batter pack; when the battery pack is not working, you can adjust the fixing pressure of the battery pack through the pressure-adjustable fixing mechanism 5 to reduce the pressure on the sealing ring, and then adjust the pressure back when working to meet the working demand of the battery pack.

It is apparent to those skilled in the art that the present invention is not limited to the details of the exemplary embodiments described above, and that it is capable of being realized in other specific forms without departing from the spirit or essential features of the invention. Therefore, the embodiments should be regarded as exemplary and non-limiting from either point of view, and the scope of the present invention is limited by the appended claims and not by the above description, and therefore is intended to encapsulate all variations falling within the meaning and scope of the equivalent elements of the claims. Any appended markings in the claims should not be considered as limiting the claims involved.

1. A fuel cell polar plate structure, comprising a battery block, said battery block consists of a bipolar plate), carbon papers and a proton exchange membrane, wherein said battery block further comprises water-holding sheets; said bipolar plate includes two plate bodies; each said plate body has a reaction bath opened on an outer surface; the left and right sides of said reaction bath are provided with inlet outlet holes and the front and rear sides of the reaction bath are provided with water crossing ports; said water crossing ports penetrate through the outer surface of the plate body, and grooves are formed in the surfaces of the water crossing ports and extend into the reaction bath, and there are guide slots evenly distributed on the inner wall of the grooves; the number of said carbon paper and water-holding sheet are both two, and said carbon papers and water-holding sheets are stacked and distributed on both sides of the proton exchange membrane; with the water-holding sheet between the carbon paper and the proton exchange membrane; the carbon paper and the water-holding sheet are embedded in the reaction bath, and the guide slots are distributed between the carbon paper and the water-holding sheet, and both sides of the water-holding sheet are integrally connected with a water-permeable block which is embedded in the water crossing port; the water-holding sheet is honeycomb-shaped, and is made of a mixture of activated carbon and perfluorosulfonic acid resin.

2. A fuel cell stack, produced using the fuel cell polar plate structure as claimed in claim 1, comprising a plurality of battery blocks, current collectors, insulating plates and end plates, wherein said battery blocks being stacked end to end to form a battery pack, and said current collectors are distributed on both sides of the battery pack; the insulating plates are attached to the side surfaces of the current collectors, the end plates are attached to the side surfaces of the insulating plates, and pressure-adjustable fixing mechanisms are fixed to the outer surfaces of the end plates; said pressure-adjustable fixing mechanism comprising a housing, inside the housing is provided with a servo motor which is fixed to the end plate, and an active bevel gear is fixed at the output end of said servo motor, and both sides of said active bevel gear are engaged with a driven bevel gear, and an inside of each said driven bevel gear is telescopically connected with a push rod, and the end of the push rod back from the driven bevel gear penetrates the housing and abuts two curved pieces, and an end of the curved piece back from the push rod holds on to a tie rod.

3. The fuel cell stack according to claim 2, wherein a bearing sleeve is attached to an outer surface of said driven bevel gear by means of a bearing which is fixed to the end plate; one end of said push rod is tapered, and an outer surface of the other end of said push rod is formed with an external thread; an inner wall of said driven bevel gear is provided with an internal thread, and the push rods are in threaded connection with the driven bevel gears.

4. The fuel cell stack according to claim 3, wherein both ends of said curved piece are curved and said curved piece is against the outer surface of the end plate; both ends of said tie rod are provided with U-shaped notches, a shaft pin is fixed in the U-shaped notch, and said curved piece is inserted in the U-shaped notch and against the shaft pin; an end of said curved piece against the push rod is thickening outwardly, the number of said tie rod is four, both ends of each said tie rod cooperate with two curved pieces.

5. The fuel cell stack according to claim 2, wherein said curved piece is provided with a pressure seat at one end near the tie rod, said pressure seat consists of a pressure rod and connection blocks, the pressure rod presses against the lowest point of an arc-shaped surface of the curved piece, both ends of the pressure rod are each fixed to a connection block, and the connection blocks are fixed to the end plate.

6. The fuel cell stack according to claim 2, wherein the outer surface of said push rod is fitted with a linear bearing, and said linear bearing is fixed to an inner wall of the housing.
